(19) United States
(12) Patent Application Publication
(10) Pub. No.: US 2025/0328120 A1
(43) Pub. Date: Oct. 23, 2025

(54) PROGRAMMABLE LOGIC CONTROLLER WITH FAIL-SAFE INPUT/OUTPUT EXPANSION WITHIN CENTRAL PROCESSING UNIT

(71) Applicant: Siemens Aktiengesellschaft, München (DE)

(72) Inventors: William Keith Bryant, Johnson City, TN (US); James Allen Knoop, Flag Pond, TN (US); Michael O'Leary, Johnson City, TN (US); Christian Pfanz, Velburg (DE); Thomas Brian Hartley, Johnson City, TN (US); Markus Kempf, Nürnberg (DE)

(73) Assignee: Siemens Aktiengesellschaft, München (DE)

(21) Appl. No.: 18/640,161

(22) Filed: Apr. 19, 2024

(51) Int. Cl. G05B 19/05

(52) U.S. Cl. CPC G05B 19/054; G05B 2219/1105

(57) ABSTRACT

A fail-safe central processing unit for a programmable logic controller (PLC) includes one or more sub-slot(s) configured to receive a signal board with multiple input/output (I/O) channels, wherein the signal board is configured as a fail-safe signal board and allows expansion of multiple fail-safe VO channels to the fail-safe central processing unit.

### TECHNICAL FIELD

Aspects of the present disclosure generally relate to industrial and other automation systems, and more specifically to a fail-safe central processing unit (CPU) with internal fail-safe input/output (I/O) expansion, and to a programmable logic controller (PLC) with such a fail-safe central processing unit (CPU).

### BACKGROUND ART

Industrial automation systems are used in different industrial fields to automatically perform a plurality of tasks, for example in a manufacturing process or an assembly line of a production facility. Industrial automation systems comprise a plurality of interconnected components, such as for example sensors, actuators, and control devices. The control devices can be for example programmable logic controllers for controlling and monitoring process parameters.

A programmable logic controller (PLC) is used to monitor input signals from a variety of input points (input sensors) which report events and conditions occurring in a controlled process. A control program stored in a memory within the PLC is configured to instruct the PLC what actions to take upon encountering specific input signals or conditions. In response to these input signals, the PLC derives and generates output signals which are transmitted via PLC output points to various output devices, such as actuators and relays, to control the process. The input points and output points referred to above are typically associated with input modules and output modules, respectively. Input modules and output modules are collectively referred to as I/O modules herein. Those skilled in the art may also refer to I/O modules as I/O cards or I/O boards. The I/O modules are typically pluggable into respective slots located on a backplane board of the PLC or provided as distributed I/O connected through a network interface.

Standard I/O modules do not perform safety functions. Safety functions are executed by designated safety modules or safety relays configured to bring a whole system to a safe state. In contrast, fail-safe I/O modules perform safety functions, for example enter a safe state immediately when an error occurs or remain in a safe mode. Fail-safe systems or components are used wherever maximum safety must be guaranteed for people, machine or the environment, and accidents and damage resulting from a fault must be avoided.

### SUMMARY

Briefly described, aspects of the present disclosure relate to industrial and other automation systems, and more particularly to a fail-safe input/output expansion within a fail-safe central processing unit and associated programmable logic controller.

More specifically, a first aspect of the present disclosure provides a fail-safe central processing unit for a programmable logic controller, the central processing unit comprising at least one sub-slot configured to receive a signal board comprising multiple input/output channels, wherein the signal board is configured as a fail-safe signal board and allows expansion of multiple fail-safe I/O channels to the fail-safe central processing unit.

A second aspect of the present disclosure provides a distributed control system comprising a plurality of system modules, and a fail-safe central processing unit comprising at least one sub-slot configured to receive a signal board comprising multiple input/output channels, wherein the signal board is configured as a fail-safe signal board and allows expansion of multiple fail-safe I/O channels to the fail-safe central processing unit.

### BRIEF DESCRIPTION OF THE DRAWINGS

FIG. 1 illustrates a schematic diagram of a known control system in accordance with an exemplary embodiment of the present disclosure.

FIG. 2 illustrates a schematic diagram of a known distributed control system with distributed I/O modules in accordance with an exemplary embodiment of the present disclosure.

FIG. 3 illustrates a front view of a fail-safe central processing unit of a programmable logic controller in accordance with an exemplary embodiment of the present disclosure.

FIG. 4 illustrates a front view of signal board interface connectors for a fail-safe central processing unit in accordance with an exemplary embodiment of the present disclosure.

FIG. 5 illustrates a schematic diagram of fail-safe digital inputs and outputs in connection with a safety function for a fail-safe central processing unit incorporating a fail-safe signal board in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. They are described in the context of a fail-safe central processing unit that allows expansion of fail-safe input/output channels within the fail-safe central processing unit.

The components and materials described hereinafter as making up the various embodiments are intended to be illustrative and not restrictive. Many suitable components and materials that would perform the same or a similar function as the materials described herein are intended to be embraced within the scope of embodiments of the present disclosure. Like reference symbols in the various drawings indicate like elements.

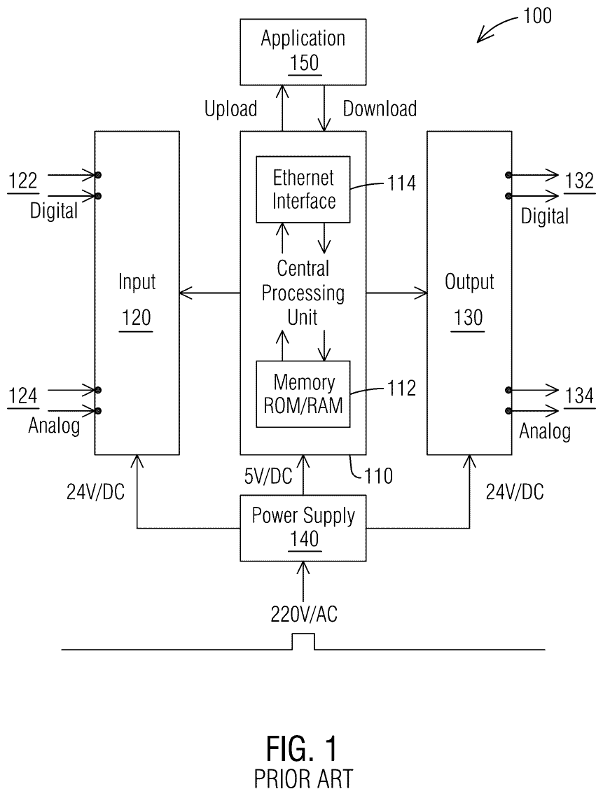

FIG. 1 illustrates a schematic diagram of a known control system 100 comprising multiple I/O channels in accordance with an exemplary embodiment of the present disclosure.

In an exemplary embodiment, the control system 100 can be configured and/or comprises one or more programmable logic controllers (PLCs), which can comprise multiple modules. As noted, PLCs are typically used in combination with automation systems in different industrial fields to automatically perform a plurality of tasks, for example in a manufacturing process or an assembly line of a production facility. PLCs are control devices for controlling and monitoring process parameters.

The control system 100, e. g. PLC, comprises a central processing unit (CPU) 110, an input 120 comprising digital and/or analog input channels 122, 124, an output 130 comprising digital and/or analog output channels 132, 134 and a power supply 140 which supplies power, specifically direct current (DC) power, to the CPU 110, the input 120 and the output 130. The input 120 and output 130 typically operate with 24 volts (V) direct current (DC) and the CPU 110 typically operates with 3.3V DC. The CPU 120 may further comprise one or more memories (ROM and/or RAM) 112 and one or more Ethernet interface(s) 114. The input 120 and output 130 are collectively referred to as I/O modules herein. It is noted that the control system 100 as described in connection with FIG. 1 is only one example of a control system, e. g., a PLC, wherein such a control system 100 may comprise many other types and/or variations of components or connections. For example, such control systems may be operated, instead of 24V, with 12V, 60V, 120VAC or 230VAC. Further, the control system 100 may comprise a CAN bus interface (instead of Ethernet interface), etc.

The CPU 110 monitors input signals from the input channels 122, 124, provided by input sensors that report events and conditions occurring in a controlled process. An application 150, herein also referred to as control program, is downloaded and stored within the CPU 110 and comprises instructions what actions to take upon encountering specific input signals or conditions. In response to the input signals, the CPU 110 derives and generates output signals which are transmitted via the output channels 132, 134 to various output devices, such as actuators and relays. The CPU 110, input 120, and output 130 can be standard components or can be fail-safe components (units). Fail-safe behavior of a functional unit means that the unit transitions to a pre-defined safe state if it is no longer able to perform its intended function.

Further components of the control system 100 may include operator terminals which provide interfaces to the control system for monitoring, controlling, and displaying information to an operator or end user. Operator terminals are also known as Human-Machine-Interface (HMI) devices which allow effective operation and control of the components and devices of the automation system from the human end, i. e. the operator or end user, while the components/devices of the automation system feed information back to the operator/end user. It should be noted that those skilled in the art are familiar with such control system and PLCs.

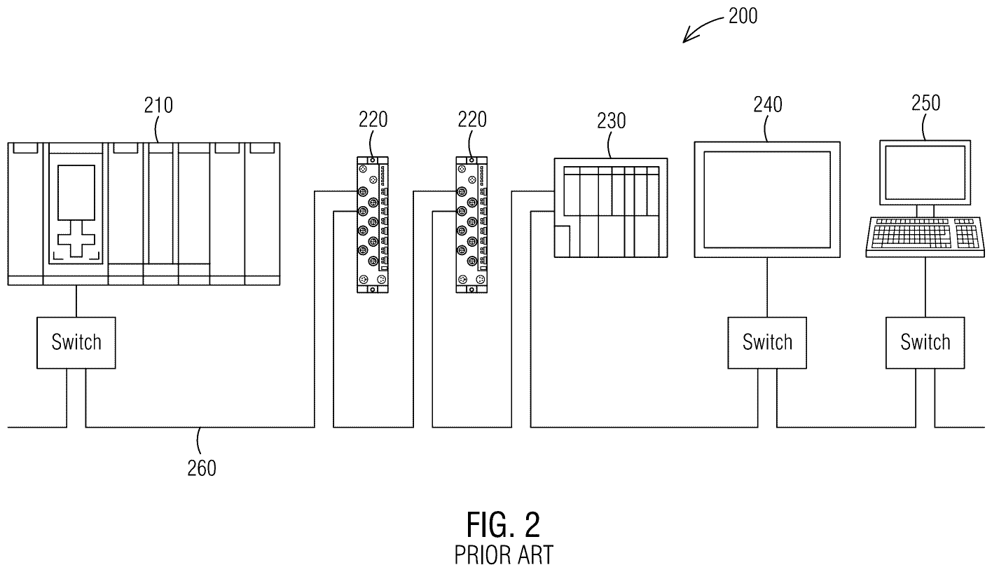

FIG. 2 illustrates a schematic diagram of a known control system 200 with distributed I/O modules in accordance with an exemplary embodiment of the present disclosure.

A plant configuration often features multiple I/O components within a central automation system. Wiring of I/O components installed at a distance away from an automation system may soon become highly complex and susceptible to electromagnetic interference. Distributed I/O systems provide a solution for such configurations, because they include field devices with a wide range of I/O options, and the field devices are operated locally in a distributed configuration. These field devices can include digital and analog channels, temperature measurements, counter inputs etc.

The control system 200 comprises multiple distributed modules and components which together form the distributed system 200. The components include controller 210, e. g., CPU, multiple different I/O devices 220, 230, including analog and/or digital inputs/outputs, a human-machine-interface (HMI) device 240 and programming interface 250. The components are operably coupled via industrial ethernet 260, or other suitable communication networks, which ensures communication between sensors, actuators, and the I/O modules and components of the system 200. It should be noted that FIG. 2 illustrates a simplistic view of distributed control system 200, and further details will not be explained herein because one of ordinary skill in the art is familiar with such a control system 200. It is noted that the control system 200 described with reference to FIG. 2 is only one example, wherein such a control system 200 may comprise other and/or different modules, and/or other types and/or variations of components and connections.

The multiple modules and components can be standard components or can be fail-safe components (units). Fail-safe behavior of a functional unit means that the unit transitions to a pre-defined safe state if it is no longer able to perform its intended function.

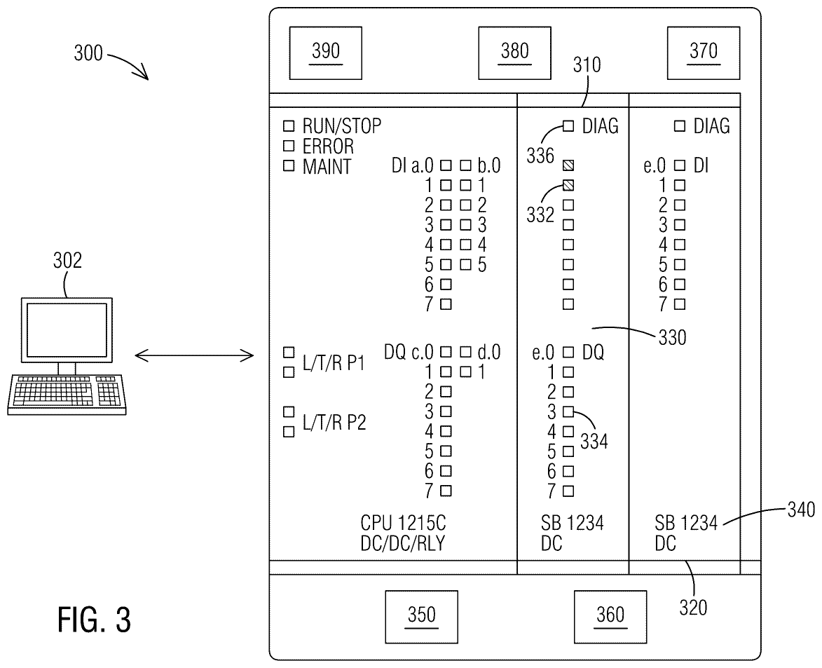

FIG. 3 illustrates a front view of a fail-safe central processing unit 300 for a control system, e. g., programmable logic, controller in accordance with an exemplary embodiment of the present disclosure.

The fail-safe central processing unit 300 is herein also referred to as F-CPU 300. As noted earlier, fail-safe behavior of a functional unit means that the unit transitions to a pre-defined safe state if it is no longer able to perform its intended function.

Typically, fail-safe CPUs can only expand their fail-safe I/O channels by adding additional separate I/O module(s) to their respective I/O bus. In accordance with an exemplary embodiment of the present disclosure, an expansion of fail-safe I/O channels directly within the F-CPU 300 is provided. The F-CPU 300 comprises at least one sub-slot 310 configured to receive a signal board 330 comprising multiple input/output (I/O) channels. Specifically, the signal board 330 is configured as a fail-safe signal board 330, herein referred to as F-SB 330, and allows expansion of multiple fail-safe I/O channels to the F-CPU 300. In other words, the F-SB 330 is integrated into the F-CPU 300, e. g., into the F-CPU 300 housing/case. In operation, the F-SB 330 is operably coupled to the F-CPU 300. In this example, the F-SB 330 transitions to a pre-defined safe state when the F-SB 330 is unable to perform as intended.

In another embodiment, the F-CPU 300 comprises a first sub-slot 310 and a second sub-slot 320, wherein each sub-slot 310, 320 is configured to receive either a F-SB 330 or a standard signal board 340, herein referred to as S-SB 340. The F-CPU 300 as shown in FIG. 3 includes the F-SB 300 and the S-SB 340 inserted into the sub-slots 310, 320. In other examples, the F-CPU 300 may comprise two fail-safe signal boards or two standard signal boards, or the F-CPU 300 may not comprise any signal boards. In this case, the sub-slots 310, 320 are empty and protected by a cover.

FIG. 3 illustrates other components of the F-CPU 300, only shown schematically, such as power connections 350, output terminal 360, input terminal 370, processor 380 (e. g., ASIC), and communication(s) connection(s) 390. The connection(s) 390 include for example Ethernet connections. Further, an engineering system 302 allows a user to configure, maintain, and operate different applications including fail-safe application(s) of the F-CPU 300. Engineering system 320 and F-CPU 300 communicate via PROFINET and/or PROFIBUS. PROFINET is an industry technical standard for data communication over Industrial Ethernet (industrial Ethernet protocol), and PROFIBUS is a serial fieldbus.

The F-CPU 300 comprises several indicator light-emitting diodes (LEDs), that indicate a status of different components. In an embodiment, the F-SB 330 comprises a status display comprising multiple indicator light emitting diodes (LEDs). More specifically, the status display comprises indicator LEDs 332, 334 for input/output channels and an indicator LED 336 for the F-SB 330. In the example of FIG. 3, the indicator LED 336 is labelled “DIAG” and may light green or red, depending on a status of the F-SB 330. The DIAG LED 336 and each channel LED 332, 334 have one light-pipe which is shared by green and red LEDs. For example, the DIAG LED 336 is green ON when configuration/parameterization has been completed. DIAG LED 336 is red ON for inconsistent hardware and/or firmware versions. Further, the LED 336 may be red blinking or green blinking in other situations or scenarios. The F-SB 330 may comprise up to eight input channels, i. e., between one and eight input channels and may comprise up to eight output channels, i. e., between one and eight output channels, for example digital input and output channels. The indicator LEDs 332, 334 will light up in accordance with the utilized channels.

In the example of FIG. 3, the F-SB 330 comprises two active digital input channels, and thus two indicator LEDs 332 are activated. The F-SB 330 may comprise up to eight input channels. The F-SB 330 comprises eight active digital output channels and thus eight indicator LEDs 334 are activated, for example in green light. The indicator LEDs 332, 334 may be green ON, green blinking, red ON or red blinking, depending on their respective status. For example, green ON indicates that input/output state is on. Red ON may indicate a sensor supply fault for certain input channels.

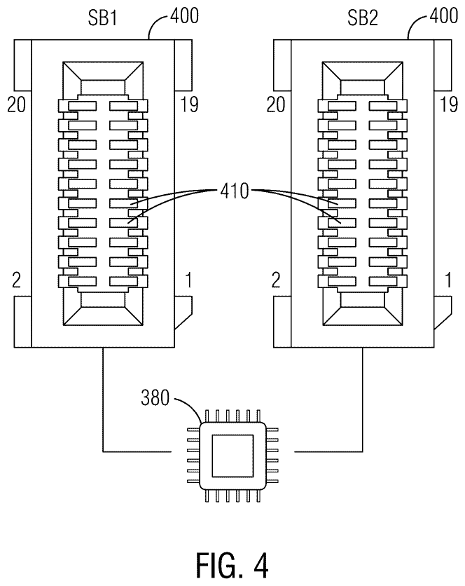

FIG. 4 illustrates a front view of signal board interface connectors 400 for a fail-safe central processing unit 300 in accordance with an exemplary embodiment of the present disclosure.

The F-CPU 300 comprises at least one signal board interface connector 400 for operably coupling the F-SB 330 to the F-CPU 300. In an example, the F-CPU 300 comprises two signal board interface connectors 400, since the F-CPU 300 comprises two sub-slots 310, 320 for connecting two signal boards 330, 340. The signal board interface connector(s) 400 support(s) adding various types of signals boards to the F-CPU 300.

The signal board interface connector 400 is accessible via the sub-slot(s) 310, 320. The signal boards, for example F-SB 330 and S-SB 340, are inserted into the sub-slots 310, 320. The interface connectors 400 are located at an end of the sub-slots 310, 320, wherein the signal boards 330, 340 are plugged into the interface connectors 400 at that end and are flush with the housing of the F-CPU 300 at an opposite end (see FIG. 3).

In operation, the F-SB 330 is operably coupled to the F-CPU 300 via the signal board interface connector 400. Similarly, if the signal board is a standard signal board, such as S-SB 340, the S-SB 340 is operably coupled to the F-CPU 300 via the interface connector 400. The interface connector(s) 400 are connected to the processor 380 of the F-CPU 300. For example, I/O signals may be multiplexed inside the processor 380 to support various functions of the connected signal boards, e. g. F-SB 330, S-SB 340.

The signal board interface connector 400 comprises pins 410, wherein the pins 410 are used for different functions. For example, eight out of the 20 pins are general purpose input/output channels (GPIO). Other pins are utilized for functional earth ground, core ground, clock, real time clock backup, signal data, etc. For the F-SB 330, some of the pins 410 are used for physical signal board location detection by the F-SB 330. The GPIO connected to the pins 410 may be configured in a variety of ways.

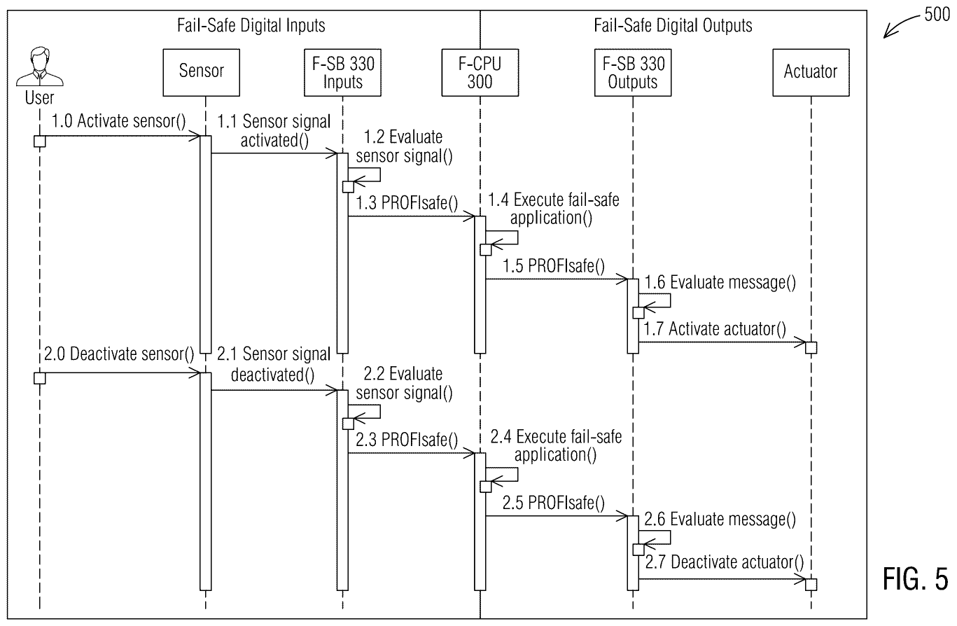

FIG. 5 illustrates a schematic diagram of fail-safe digital inputs and outputs in connection with a safety function for a fail-safe central processing unit incorporating a fail-safe signal board in accordance with an exemplary embodiment of the present disclosure.

The F-SB 330 is configured to support fail-safe safety functions or applications including an emergency stop safety function, in conjunction with the F-CPU 300. For example, an emergency stop safety function can be used to turn off an electric motor (actuator) in emergency situations.

With reference to the diagram 500 of FIG. 5, the F-SB 330 is configured to provide input signals to the F-CPU 300, and wherein the F-CPU 300 is configured to execute fail-safe applications based on the input signals from the F-SB 330. After execution of the fail-safe application(s), the F-CPU 300 provides output signals to the F-SB 330, for example via PROFIsafe Ethernet protocol. The F-SB 330 then activates the connected actuator, e. g. electric motor, based on the output signals including output status received from the F-CPU 300.

| ID | Message | From Object | To Object | Notes |
|---|---|---|---|---|
| 1.0 | Activate Sensor | User | Sensor | User activates sensor |
| 1.1 | Sensor signal activated | Sensor | F-SB Inputs | Activated sensor signal |
| | | | | detected by fail-safe digital |
| | | | | input channel of F-SB |
| 1.2 | Evaluate sensor signal | F-SB Inputs | F-SB Inputs | F-SB evaluates sensor signal |
| | | | | and provides information by |
| | | | | use of PROFIsafe protocol |
| 1.3 | PROFIsafe | F-SB Inputs | F-CPU | Sensor information passed to |
| | | | | the F-CPU via PROFIsafe |
| | | | | protocol |
| 1.4 | Execute fail-safe | F-CPU | F-CPU | F-CPU executes fail-safe |
| | application | | | application(s) as defined by |
| | | | | user |
| 1.5 | PROFIsafe | F-CPU | F-SB | F-CPU sends desired output |
| | | | Outputs | state to the F-SB via |
| | | | | PROFIsafe protocol |
| 1.6 | Evaluate message | F-SB | F-SB | F-SB checks PROFIsafe |
| | | Outputs | Outputs | message and extracts output |
| | | | | data |
| 1.7 | Activate actuator | F-SB | Actuator | F-SB activates actuator via |
| | | Outputs | | respective output channel |
| 2.0 | Deactivate sensor | User | Sensor | User deactivates sensor |
| 2.1 | Sensor signal | Sensor | F-SB Inputs | Deactivated sensor signal |
| | deactivated | | | detected by F-SB digital input |
| | | | | channel |
| 2.2 | Evaluate sensor signal | F-SB Inputs | F-SB Inputs | F-SB evaluates sensor signal |
| | | | | and provides information via |
| | | | | PROFIsafe protocol |
| 2.3 | PROFIsafe | F-SB Inputs | F-CPU | Sensor information is passed |
| | | | | to F-CPU via PROFIsafe |
| | | | | protocol |
| 2.4 | Execute fail-safe | F-CPU | F-CPU | F-CPU executes fail-safe |
| | application | | | application(s) as defined by |
| | | | | user |
| 2.5 | PROFIsafe | F-CPU | F-SB | F-CPU sends desired output |
| | | | Outputs | state to the F-SB via |
| | | | | PROFIsafe protocol |
| 2.6 | Evaluate message | F-SB | F-SB | F-SB checks PROFIsafe |
| | | Outputs | Outputs | message and extracts output |
| | | | | data |
| 2.7 | Deactivate actuator | F-SB | Actuator | F-SB deactivates actuator via |
| | | Outputs | | respective output channel |

The described technology allows fail-safe I/O expansion directly into the F-CPU 300 through addition of one or more fail-safe signal board(s) 330. The fail-safe SB 330 is inserted directly into the provided F-CPU sub-slot 310, 320 and expands the physical I/O space of the F-CPU 300. Functional safety integrity ratings equivalent to fail-safe signal modules (SMs) are achieved through specialized F-address assignment verification. Providing fail-safe input/output through an inherent CPU-SB interface (interface connectors 400) allows direct expansion of the CPU's safety I/O and provides improved cost effectiveness as compared to an expansion module concept. This allows a small number of fail-safe I/O to be cost-effectively incorporated within the F-CPU 300 without signal module expansion.

1. A fail-safe central processing unit for a programmable logic controller (PLC), the fail-safe central processing unit comprising:
at least one sub-slot configured to receive a signal board comprising multiple digital input/output (I/O) channels,
wherein the signal board is configured as a fail-safe signal board and allows expansion of multiple fail-safe digital I/O channels to the fail-safe central processing unit.

2. The fail-safe central processing unit of claim 1, further comprising:
at least one signal board interface connector for operably coupling the fail-safe signal board to the fail-safe central processing unit.

3. The fail-safe central processing unit of claim 2,
wherein the at least one signal board interface connector is accessible via the at least one sub-slot, and wherein, in operation, the fail-safe signal board is operably coupled to the fail-safe central processing unit via the at least one signal board interface connector.

4. The fail-safe central processing unit of claim 1,
comprising a first sub-slot and a second sub-slot, wherein each sub-slot is configured to receive a fail-safe signal board or a standard signal board.

5. The fail-safe central processing unit of claim 1,
wherein the fail-safe signal board comprises at least one fail-safe digital I/O channel.

6. The fail-safe central processing unit of claim 5,
wherein the fail-safe signal board is configured to support fail-safe safety functions including an emergency stop safety function.

7. The fail-safe central processing unit of claim 6,
wherein the fail-safe signal board is configured to evaluate a sensor signal and provide sensor input information to the fail-safe central processing unit,
wherein the fail-safe central processing unit is configured to execute a fail-safe application in response to the sensor input information, and
wherein the fail-safe central processing unit is configured to provide output information to the fail-safe signal board for activating or deactivating an actuator based on the output information.

8. The fail-safe central processing unit of claim 1,
wherein the fail-safe signal board comprises a status display comprising multiple indicator light emitting diodes.

9. The fail-safe central processing unit of claim 8,
wherein the status display is configured to display a status of the I/O channels via dedicated indicator light emitting diodes and a diagnostics status of the fail-safe signal board (330) via a diagnostics light emitting diode.

10. A programmable logic controller comprising:
a fail-safe central processing unit as claimed in claim 1.

11. A distributed control system comprising:
a plurality of system modules, and
a fail-safe central processing unit comprising at least one sub-slot configured to receive a signal board comprising multiple digital input/output (I/O) channels,
wherein the signal board is configured as a fail-safe signal board and allows expansion of multiple fail-safe digital I/O channels to the fail-safe central processing unit.

12. The distributed control system of claim 11,
wherein the plurality of system modules includes I/O devices with analog and/or digital inputs/outputs and a human-machine-interface (HMI) device.

13. The distributed control system of claim 11,
wherein the fail-safe central processing unit further comprises at least one signal board interface connector for operably coupling the fail-safe signal board to the fail-safe central processing unit.

14. The distributed control system of claim 11,
wherein the fail-safe signal board comprises at least one fail-safe digital I/O channel.

15. The distributed control system of claim 14,
wherein the fail-safe signal board is configured to support fail-safe safety functions including an emergency stop safety function.
